(19) United States
(12) Patent Application Publication
(10) Pub. No.: US 2020/0190704 A1
(43) Pub. Date: Jun. 18, 2020

(54) METHOD FOR PREPARING INVERSE OPAL COLLOIDAL CRYSTAL FIBERS

(71) Applicant: NANTONG TEXTILE & SILK INDUSTRIAL TECHNOLOGY RESEARCH INSTITUTE, Nantong (CN)

(72) Inventors: Ke-Qin ZHANG, Nantong (CN); Chen DING, Nantong (CN); Wei YUAN, Nantong (CN); Tingting LI, Nantong (CN)

(21) Appl. No.: 16/802,942

(22) Filed: Feb. 27, 2020

Related U.S. Application Data
(63) Continuation of application No. 15/745,800, filed on Jan. 18, 2018.

(30) Foreign Application Priority Data
Jul. 9, 2015 (CN) 201510400512.1

(51) Int. Cl. D01F 9/08; G02B 6/02; C04B 35/622; G02B 6/122; C08J 5/18

(52) U.S. Cl. CPC D01F 9/08; G02B 6/02295; G02B 6/02033; C04B 35/6224; G02B 6/1225; C04B 2235/526; C04B 2235/5454; C04B 2235/9653; C04B 2235/5264; C04B 2235/6028; C08J 5/18

(57) ABSTRACT

The present invention discloses a method for preparing inverse opal photonic crystal fibers. In this method, by means of vertical deposition of colloidal spheres (micron scale or nanoscale), of polystyrene shell-core structured spheres and silica particles, the inverse opal colloidal crystal fiber stripes having a length of about 3.5 cm as well as an adjustable width and thickness is obtained. The invention provides a convenient method and achieves inverse opal photonic crystal fiber stripes with a high yield and a controllable size, and there is no crack on the surface of the fibers or inside the fibers. Furthermore, the inverse opal photonic crystal stripes of the invention can be peeled off from the surface of a glass slide and used conveniently.

This application is a continuation application of Ser. No. 15/745,800, filed on Jan. 18, 2018, which is a national stage application of PCT/CN2015/084030, filed on Jul. 15, 2015, which claims the priority to Chinese Patent Application No. 201510400512.1, filed on Jul. 9, 2015, all of which are incorporated herein by reference in their entirety.

### FIELD OF THE INVENTION

The present invention relates to a method for preparing inverse opal colloidal crystal fibers.

### DESCRIPTION OF THE RELATED ART

Colloidal crystals prepared from dielectric material silica and monodisperse polymer spheres are commonly used to obtain controllable three-dimensional periodic dielectric materials such as photonic crystals. These materials have an ordered structure in the various dimensions, and have a blocking effect on the light of particular wavelengths because the Bragg diffraction can change the propagation of light. The light can be reflected and interfered many times in the crystals, thus, the photonic crystals exhibit the property of photonic band gap for the light of particular wavelengths. The photonic crystals have been extensively applied due to such property, for example, enhancing or inhibiting synchronous light emission, light filtering and light conversion, and the photonic crystals can control the transmission of visible light and infrared light. Due to the property of full bandgap, the photonic crystals of inverse opal structure are widely used in the fields of waveguide, optical storage and light filtering and so on.

Because of the advantage of propagation of photons, inverse opal structured photonic crystal fibers assembled by the colloidal particles are of considerable interest. Currently, there are two main preparation methods of inverse opal structured photonic crystals: the template method and capillary growth method. In the template method, microchannels are obtained by photoetching, the polymer colloidal particles are filled in the microchannels, and inorganic precursors such as silica or titanium dioxide solutions are filled in the gap of colloidal crystals, and finally, the polymer colloidal crystal template is removed by sintering, leaving inverse opal photonic crystal fibers having a regular arrangement of air spheres. This method is very complicated and costly, and has a poor yield and limited size of fibers. In the capillary growth method, a polymer colloidal solution is filled in or applied to the inner surface of the capillary tube, and then the template is removed, similarly to the template method. The capillary support method has a poor yield, and crack defects will be formed on the surface of fibers, this will produce adverse effects to the transmission of lights.

### SUMMARY OF THE INVENTION

In order to solve the above technical problems, the object of the present invention is to provide a method for preparing inverse opal colloidal crystal fibers. The method has a high yield, the size of the obtained fibers is controllable, and there is no crack in the interior of fiber.

For the above purpose, the invention provides a method for preparing inverse opal colloidal crystal fibers, the method comprises the steps of:

(1) forming a layer of a copolymer of methyl methacrylate (MMA) and acrylic acid (AA) on the surface of polystyrene (St) microspheres by a microemulsion method, to obtain shell-core structured P-(St-MMA-AA) microspheres with a polystyrene core;

(2) uniformly mixing a 0.3%-1.0% w/v dispersion solution of the P-(St-MMA-AA) microspheres with silica sol nanospheres by a weight ratio of 1:0.3-0.6 to form a colloidal solution, and obtaining colloidal crystal fiber stripes after vertical deposition of the P-(St-MMA-AA) microspheres and silica nanospheres and drying in an oven under 50° C.; and

(3) sintering the colloidal crystal fiber stripes in an oven under 500° C. for 2 hrs to remove the P-(St-MMA-AA) microspheres, to get the inverse opal colloidal crystal fibers.

Preferably, in the step (1), 2 ml methyl methacrylate, 2 ml acrylic acid, 38 ml polystyrene, 200 ml deionized water, 0-0.033 g sodium dodecyl sulfate (SDS), and 1 g sodium bicarbonate are added to a flask and stirred uniformly, then 2 ml of an ammonium persulfate solution is added after stirring under 70° C. for 0.5 h, subsequently the temperature is raised to 80° C. to continue the reaction under stirring for 10 hrs to generate the P-(St-MMA-AA) microspheres having a size of 190-450 nm.

Preferably, in the step (2), the dispersion solution of the P-(St-MMA-AA) microspheres are prepared from the P-(St-MMA-AA) microspheres having a size of 300 nm.

Preferably, the average size of silica particles is 10-20 nm in the silica colloidal solution.

Preferably, in the step (2), a 0.4%-0.6% w/v dispersion of the P-(St-MMA-AA) microspheres and the silica sol nanospheres are mixed uniformly by a weight ratio of 1:0.4-0.6 to form a colloidal solution, and obtaining the colloidal crystal stripes after vertical deposition of the P-(St-MMA-AA) microspheres and the silica nanospheres and drying in an oven under 50° C.

By means of the above technical solution, as compared with the prior art, the method for preparing inverse opal colloidal crystal fibers of the present invention has the following advantages:

1. inverse opal photonic crystal fibers of full bandgap can be obtained, using a simple vertical deposition process;

2. by changing the volume of the dispersion solution, the photonic crystal stripes, having a length greater than 3 cm and a width of 20 μm-300 μm can be obtained;

3. there is no crack in the interior of the photonic crystal fibers, this will facilitate the propagation of light; and

4. the yield is high, and hundreds to thousands of fibers can be prepared at a time.

### BRIEF DESCRIPTION OF THE DRAWINGS

FIG. 1 is a flow diagram of a method for preparing inverse opal colloidal crystal fibers of the present invention;

FIG. 2 shows the structural color from the inverse opal photonic stripes of the present invention.

### DESCRIPTION OF THE PREFERRED EMBODIMENTS

The invention will be further illustrated in more detail with reference to accompanying drawings. It is noted that, the following embodiments only are intended for purposes of illustration and are not intended to limit the scope of the invention.

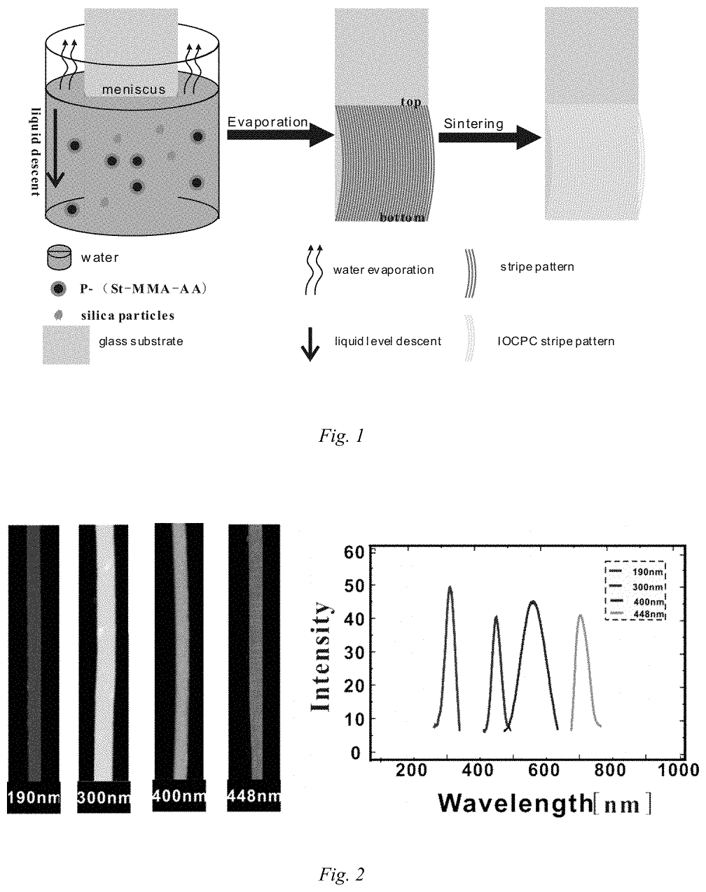

Referring to the FIG. 1, a method for preparing inverse opal photonic crystal fibers comprises the following steps:

(1) forming a layer of the copolymer of methyl methacrylate (MMA) and acrylic acid (AA) on the surface of polystyrene (St) microspheres by a microemulsion method, to obtain shell-core structured P-(St-MMA-AA) microspheres with a polystyrene core;

(2) uniformly mixing a 0.3%-1.0% w/v dispersion solution of the P-(St-MMA-AA) microspheres with silica sol nanospheres by a weight ratio of 1:0.3-0.6 to form a colloidal solution, and obtaining the colloidal crystal stripes after vertical deposition of the P-(St-MMA-AA) microspheres and the silica nanospheres and drying in an oven under 50° C.; and

(3) sintering the colloidal crystal stripes in an oven under 500° C. for 2 hrs to remove the P-(St-MMA-AA) microspheres, to get the inverse opal photonic crystal fiber.

Specifically, in the step (1), 2 ml methyl methacrylate, 2 ml acrylic acid, 38 ml polystyrene, 200 ml deionized water, 0-0.033 g sodium dodecyl sulfate (SDS), and 1 g sodium bicarbonate are added to a flask and stirred uniformly, then 2 ml of an ammonium persulfate solution is added after stirring under 70° C. for 0.5 h, subsequently the temperature is raised to 80° C. to continue the reaction under stirring for 10 hrs to generate the P-(St-MMA-AA) microspheres having a size of 190-450 nm.

### Embodiment 1

60 mg P-(St-MMA-AA) microspheres with a particle size of 190 nm and 18 mg silica particles were prepared into 20 ml dispersion solution with a 0.3% w/v of P-(St-MMA-AA) microspheres, wherein the weight ratio of P-(St-MMA-AA) microspheres and silica sol is 1:0.3. The dispersion solution was placed into a 25 ml beaker, after being uniformly mixed by ultrasonic, and then dried in an oven under 50° C. to give colloidal crystal stripes. The colloidal crystal stripes were sintered in an oven under 500° C. for 2 hrs to remove the P-(St-MMA-AA) microspheres, and inverse opal structured photonic crystal stripes were formed.

### Embodiment 2

80 mg P-(St-MMA-AA) microspheres with a particle size of 300 nm and 32 mg silica particles were prepared into 20 ml dispersion solution with a 0.4% w/v of P-(St-MMA-AA) microspheres, wherein the weight ratio of P-(St-MMA-AA) microspheres and silica sol is 1:0.4. The dispersion solution was placed into a 25 ml beaker, after being uniformly mixed by ultrasonic, then was dried in an oven under 50° C. to give colloidal crystal stripes. The colloidal crystal stripes were sintered in an oven under 500° C. for 2 hrs to remove the P-(St-MMA-AA) microspheres, and inverse opal structured photonic crystal stripes were formed.

### Embodiment 3

100 mg P-(St-MMA-AA) microspheres with a particle size of 400 nm and 50 mg silica particles were prepared into 20 ml dispersion solution with a 0.5% w/v of P-(St-MMA-AA) microspheres, wherein the weight ratio of P-(St-MMA-AA) microspheres and silica sol is 1:0.5. The dispersion solution was placed into a 25 ml beaker, after being uniformly mixed by ultrasonic, then was dried in an oven under 50° C. to give colloidal crystal stripes. The colloidal crystal stripes were sintered in an oven under 500° C. for 2 hrs to remove the P-(St-MMA-AA) microspheres, and inverse opal structured photonic crystal stripes were formed.

### Embodiment 4

80 mg P-(St-MMA-AA) microspheres with a particle size of 448 nm and 48 mg silica particles were prepared into 20 ml dispersion solution with a 0.6% w/v of P-(St-MMA-AA) microspheres, wherein the weight ratio of P-(St-MMA-AA) microspheres and silica sol is 1:0.6. The dispersion solution was placed into a 25 ml beaker, after being uniformly mixed by ultrasonic, then was dried in an oven under 50° C. to give colloidal crystal stripes. The colloidal crystal stripes were sintered in an oven under 500° C. for 2 h to remove the P-(St-MMA-AA) microspheres, and inverse opal structured photonic crystal stripes were formed.

The silica particles in the above four embodiments are irregular solid particles, and have a size of 10-20 nm.

As shown in FIG. 2, the colloidal crystal stripes were prepared by vertical deposition of the P-(St-MMA-AA) microspheres and silica, and drying in an oven under 50° C. The colloidal crystal stripes have a length of about 3.5 cm and a width of 50 μm-200 μm. The colloidal crystal stripes were sintered in an oven under 500° C. for 2 hrs to remove the P-(St-MMA-AA) microspheres, and inverse opal structured photonic crystal stripes were obtained, wherein silica particles with a refractive index of 1.56 were filled in the gap of close-packed air spheres. Inverse opal structured photonic crystal stripes of different colors were obtained with P-(St-MMA-AA) microspheres of different sizes.

It can be seen from the above embodiments that, in the invention, when the dispersion solution has a 0.4%-0.6% w/v of P-(St-MMA-AA) microspheres of 300 nm, and the weight ratio of the P-(St-MMA-AA) microspheres and silica sol is 1:0.4-0.6, the obtained inverse opal structured photonic crystal stripes have the optimal length and width. In the invention, the P-(St-MMA-AA) microspheres of 300 nm are used, so that they can uniformly interact with the silica particles during the self-assembly via the vertical deposition, and the inverse opal colloidal crystal fibers are obtained without crack on its' surface and in its' interior, and the inverse opal colloidal crystal fibers can be peeled off from the surface of a glass slide and used conveniently.

The above preferred embodiments are described for illustration only, and are not intended to limit the scope of the invention. It should be understood, for a person skilled in the art, that various improvements or variations can be made therein without departing from the spirit and scope of the invention, and these improvements or variations should be covered within the protecting scope of the invention.

What is claimed is:

1. A method for preparing non-crack inverse opal colloidal crystal fibers, comprising steps of:
(1) forming a layer of a copolymer of methyl methacrylate (MMA) and acrylic acid (AA) on the surface of polystyrene (St) microspheres by a microemulsion method, to obtain shell-core structured P-(St-MMA-AA) microspheres with a polystyrene core;
(2) uniformly mixing a 0.3%-1.0% w/v dispersion solution of the shell-core structured P-(St-MMA-AA) microspheres with silica nanoparticles by a weight ratio of 1:0.4-0.6 to form a colloidal solution, and obtaining colloidal crystal fiber stripes after vertical deposition of the colloidal solution and drying the colloidal solution in an oven under 50° C.; and
(3) sintering the colloidal crystal fiber stripes in an oven under 500° C. for 2 hrs to remove the shell-core structured P-(St-MMA-AA) microspheres, to get the inverse opal colloidal crystal fibers,
wherein the silica nanoparticles are irregular solid particles, and have a refractive index of 1.56;
wherein the inverse opal colloidal crystal fibers have a length of about 3.5 cm and a width of 50 μm-200 μm; and
wherein the inverse opal colloidal crystal fibers do not have crack on surface and in interior thereof.

2. The method as claimed in claim 1, wherein in the step (1), 2 ml methyl methacrylate, 2 ml acrylic acid, 38 ml polystyrene, 200 ml deionized water, 0-0.033 g sodium dodecyl sulfate (SDS), and 1 g sodium bicarbonate are added to a flask and stirred uniformly, then 2 ml of an ammonium persulfate solution is added after stirring under 70° C. for 0.5 h, subsequently the temperature is raised to 80° C. to continue the reaction under stirring for 10 hrs to generate the shell-core structured P-(St-MMA-AA) microspheres.

3. The method as claimed in claim 1, wherein in the step (2), the dispersion solution of the shell-core structured P-(St-MMA-AA) microspheres are prepared from the shell-core structured P-(St-MMA-AA) microspheres.

4. The method as claimed in claim 3, wherein the average size of the silica nanoparticles is 10-20 nm in the colloidal solution.

5. The method as claimed in claim 3, wherein in the step (2), a 0.4%-0.6% w/v dispersion solution of the shell-core structured P-(St-MMA-AA) microspheres and the silica nanoparticles are mixed uniformly by a weight ratio of 1:0.4-0.6 to form the colloidal solution.
